(19) United States
(12) Patent Application Publication
(10) Pub. No.: US 2022/0232021 A1
(43) Pub. Date: Jul. 21, 2022

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: FUJITSU LIMITED, Kawasaki-shi (JP)

(72) Inventor: Tsuyoshi TANIGUCHI, Katsushika (JP)

(73) Assignee: FUJITSU LIMITED, Kawasaki-shi (JP)

(21) Appl. No.: 17/517,325

(22) Filed: Nov. 2, 2021

(30) Foreign Application Priority Data
Jan. 20, 2021 (JP) 2021-007397

(51) Int. Cl. H04L 29/06; G06Q 20/40

(52) U.S. Cl. CPC H04L 63/1416; G06Q 20/4016

(57) ABSTRACT

A computer-implemented method includes: collecting transaction data concerning a specific virtual currency address from a blockchain; decrypting address information based on transaction details specified in the collected transaction data; collecting threat information concerning the address information based on the decrypted address information; and detecting a change in an attack scheme of a cyberattack using the virtual currency address, based on a time-series change in at least one item included in the transaction details specified in the collected transaction data and the collected threat information.

### CROSS-REFERENCE TO RELATED APPLICATION

This application is based upon and claims the benefit of priority of the prior Japanese Patent Application No. 2021-7397, filed on Jan. 20, 2021, the entire contents of which are incorporated herein by reference.

### FIELD

The embodiments discussed herein are related to a computer-readable recording medium storing an information processing program, an information processing method, and an information processing apparatus.

### BACKGROUND

In recent years, attackers with various purposes have made cyberattacks, and general users have been daily exposed to threats of the cyberattacks on the Internet. Malicious attackers may exploit an infrastructure such as the Domain Name System (DNS) on the Internet in the same way as legitimate business operators may use it. For example, an attacker exploits the DNS by using a scheme such as Fast-Flux or domain-generation algorithms (DGAs) so that the location of a command & control (C&C) server for transmitting instructions to malware may not be found on the DNS. Meanwhile, researchers on the defending side have been improving methods for detecting such exploits, and have been accumulating many findings.

Example of the related art include as follow: Japanese Laid-open Patent Publication No. 2015-177434; and Japanese Laid-open Patent Publication No. 2020-14061.

### SUMMARY

According to an aspect of the embodiments, a computer-implemented method includes: collecting transaction data concerning a specific virtual currency address from a blockchain; decrypting address information based on transaction details specified in the collected transaction data; collecting threat information concerning the address information based on the decrypted address information; and detecting a change in an attack scheme of a cyberattack using the virtual currency address, based on a time-series change in at least one item included in the transaction details specified in the collected transaction data and the collected threat information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration example of an information processing apparatus according to an embodiment;

FIG. 2 is an explanatory diagram for explaining an example of bitcoin transactions;

FIG. 3 is an explanatory diagram for explaining an example of a bitcoin transaction;

FIG. 4 is an explanatory diagram for explaining an example of transaction data;

FIG. 5 is an explanatory diagram for explaining an example of a C&C IP concealing method;

FIG. 6 is an explanatory diagram for explaining an example of C&C Geo IP data;

FIG. 7 is an explanatory diagram for explaining an example of malware data;

FIG. 8 is a flowchart illustrating an example of attack scheme change detection processing;

FIG. 9 is a flowchart illustrating an example of a transaction time slot change detection process;

FIG. 10 is an explanatory diagram for explaining an example of a detection result;

FIG. 11 is a flowchart illustrating an example of a fee change detection process;

FIG. 12 is an explanatory diagram for explaining an example of a detection result;

FIG. 13 is a flowchart illustrating an example of a newly-exploited API and new communication bitcoin address detection process;

FIG. 14 is an explanatory diagram for explaining an example of exploited API data and API communication bitcoin address data;

FIG. 15 is an explanatory diagram for explaining an example of newly-exploited API and new communication bitcoin address data;

FIG. 16 is a flowchart illustrating an example of a C&C IP provider change detection process;

FIG. 17 illustrates an explanatory diagram for explaining an example of C&C IP provider data;

FIG. 18 is an explanatory diagram for explaining an example of C&C IP provider exploit change detection data;

FIG. 19 is a flowchart illustrating an example of a C&C IP country change detection process;

FIG. 20 is an explanatory diagram for explaining an example of C&C IP country data;

FIG. 21 is an explanatory diagram for explaining an example of a detection result;

FIG. 22 is a flowchart illustrating an example of a transaction block strategy change detection process;

FIG. 23 is an explanatory diagram for explaining an example of a detection result; and

FIG. 24 is a block diagram illustrating an example of a computer configuration.

### DESCRIPTION OF EMBODIMENTS

Without having any particular reason to persist in exploiting the DNS, attackers who make cyberattacks may use a blockchain as another channel for concealing C&C communication. In order to conceal the C&C communication using the blockchain, the attacker uses a transaction of a virtual currency (may be referred to as “cryptcurrency”, “cryptocurrency”, or “crypto-currency”) such as bitcoin (also referred to as crypto assets) using a public distributed ledger called a blockchain. Such concealment of the C&C communication using the blockchain is an attack scheme (may be referred to as “attack strategy”) that is still under development for attackers, and the attackers have been modifying and advancing the attack scheme by trial and error.

However, the related art described above is intended to detect the attack scheme using the DNS, and has a problem of having difficulty in detecting a change in the attack scheme using a blockchain.

In one aspect, an object is to provide an information processing program, an information processing method, and an information processing apparatus that are capable of detecting a change in an attack scheme of a cyberattack.

Hereinafter, an information processing program, an information processing method, and an information processing apparatus according to the embodiments will be described with reference to the drawings. In the embodiments, components having the same functions will be denoted by the same reference signs, and redundant description thereof will be omitted. The information processing program, the information processing method, and the information processing apparatus described in the following embodiments are just for exemplary purposes, and do not limit other embodiments. Any two or more of the following embodiments may be appropriately combined as long as they will not have inconsistency.

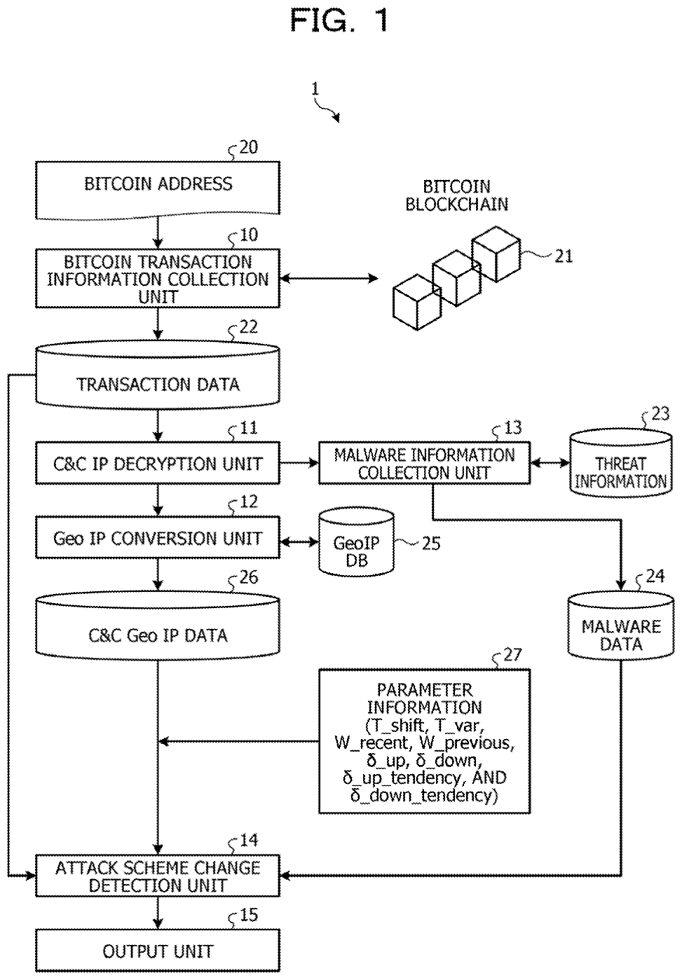

FIG. 1 is a block diagram illustrating a functional configuration example of an information processing apparatus according to an embodiment. As illustrated in FIG. 1, the information processing apparatus 1 detects an exploit of a virtual currency (may be referred to as “cryptcurrency”, “cryptocurrency”, or “crypto-currency”, such as bitcoin) by an attacker based on transactions indicated in a bitcoin blockchain 21 of the virtual currency. For example, a computer such as a personal computer (PC) is usable as the information processing apparatus 1. Note that the virtual currency (crypto assets) is not limited to the bitcoin, and may be a virtual currency such as Litecoin as long as the virtual currency uses a public distributed ledger such as the bitcoin blockchain 21.

The information processing apparatus 1 includes a bitcoin transaction information collection unit 10, a C&C IP decryption unit 11, a Geo IP conversion unit 12, a malware information collection unit 13, an attack scheme change detection unit 14, and an output unit 15.

The bitcoin transaction information collection unit 10 is a processing unit that performs transaction collection for collecting transaction data 22 specifying transactions of the virtual currency from the bitcoin blockchain 21. For example, the bitcoin transaction information collection unit 10 uses, as an input, a bitcoin address 20 for the virtual currency which is reported to be exploited in threat information such as cyber threat intelligence (CTI), and performs transaction collections for transactions originating with the bitcoin address 20 from the bitcoin blockchain 21. Next, the bitcoin transaction information collection unit 10 outputs the collected data as the transaction data 22.

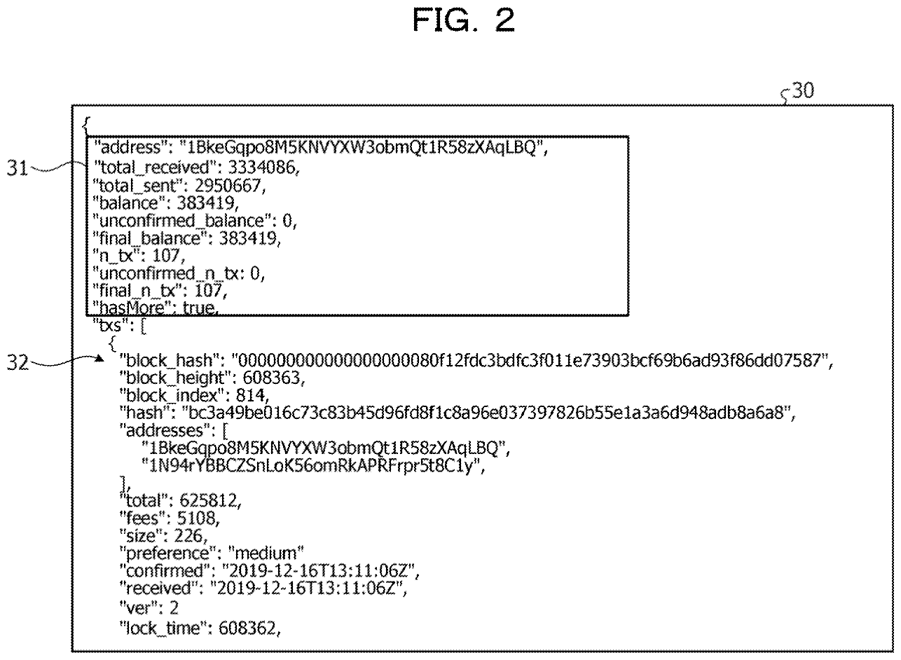

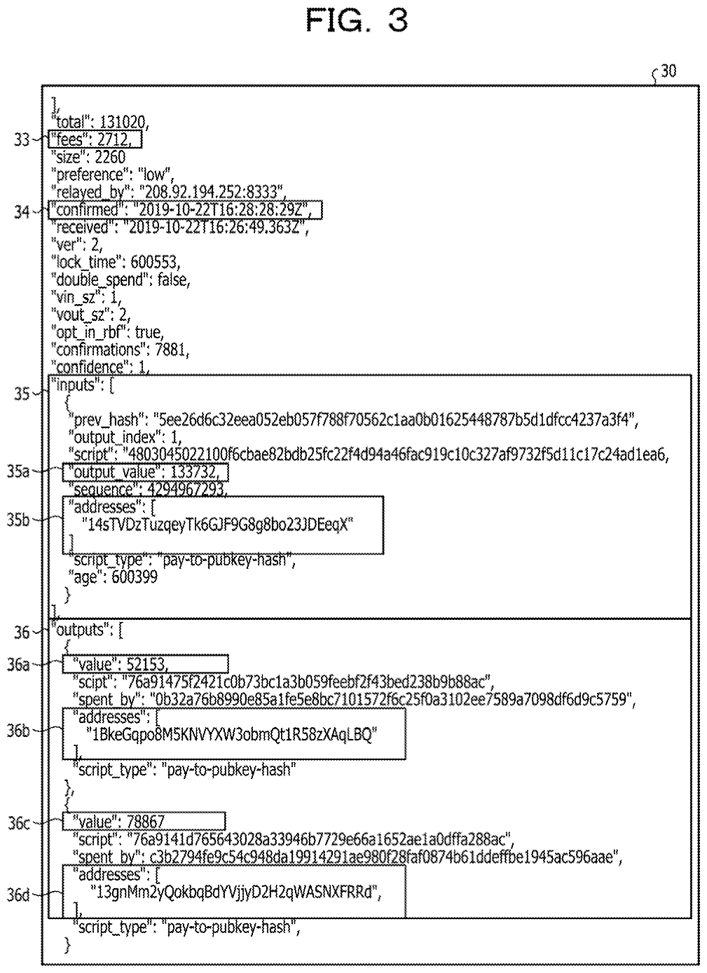

FIGS. 2 and 3 are explanatory diagrams for explaining examples of bitcoin transactions. For example, FIGS. 2 and 3 illustrate examples of bitcoin transactions collected using a transaction application programming interface (API) in API v1 of blockcypher.com. The file format in the bitcoin transactions in this example is the json format.

As illustrated in FIG. 2, exploited API data 31 in a header part of the collected bitcoin transaction specifies data such as a bitcoin address (“address”), total reception (“total_received”), and total transmission (“total_sent”). In an area 32 starting from “txs”, a list of transactions is presented in order starting from the transaction lastly added to a blockchain 2.

For example, at most 50 transactions may be collected in blockcyper.com.

For each transaction, as illustrated in FIG. 3, a “fees” area 33 specifies fees to be paid to the miner set for the transaction. A “confirmed” area 34 specifies the date and time when the transaction was confirmed (may be referred to as “approved”) in the blockchain. An “inputs” area 35 specifies data on a sender side, and an “outputs” area 36 specifies data on a receiver side.

In the “inputs” area 35, an “output_value” area 35a specifies the amount of bitcoins sent in terms of the minimum unit (satoshi). An “addresses” area 35b specifies the bitcoin address on the sender side.

In the “outputs” area 36, “value” areas 36a and 36c specify the amounts of bitcoins received in terms of the minimum unit (satoshi). Then, “addresses” areas 36b and 36d specify bitcoin addresses on the receiver side.

Referring back to FIG. 2, “block_height” in the area 32 specifies the number of the block counted from the start of the blockchain. The bitcoin transaction information collection unit 10 acquires a bitcoin transaction 30 involving the bitcoin address 20 from the area 31, and outputs the bitcoin transaction 30 as the transaction data 22.

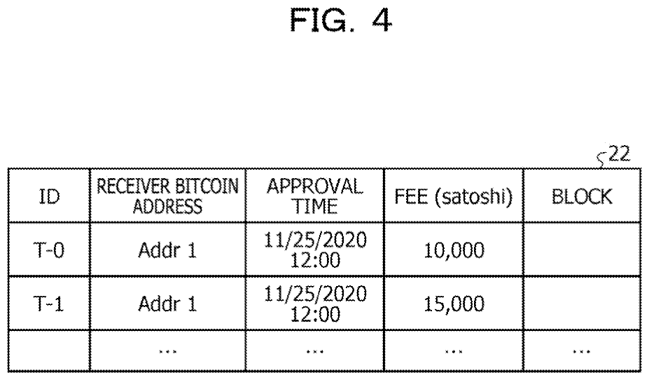

FIG. 4 is an explanatory diagram for explaining an example of the transaction data 22. As illustrated in FIG. 4, “RECEIVER BITCOIN ADDRESS” stores the bitcoin address on the receiver side. “APPROVAL TIME” stores a time when the transaction was confirmed. “FEE (satoshi)” stores fees set for the transaction. “BLOCK” stores the height of the block in which the transaction was approved (may be referred to as “confirmed”). The bitcoin transaction information collection unit 10 assigns identification information (ID) to these pieces of information and stores the ID in “ID”. Every time a new transaction is observed, the bitcoin transaction information collection unit 10 stores the data into the transaction data 22 in that way.

The C&C IP decryption unit 11 is a processing unit that uses, as an input, the transaction data 22 collected by the bitcoin transaction information collection unit 10 and decrypts, based on transaction details specified in the transaction data 22, address information (for example, C&C IP) concealed in the transaction details.

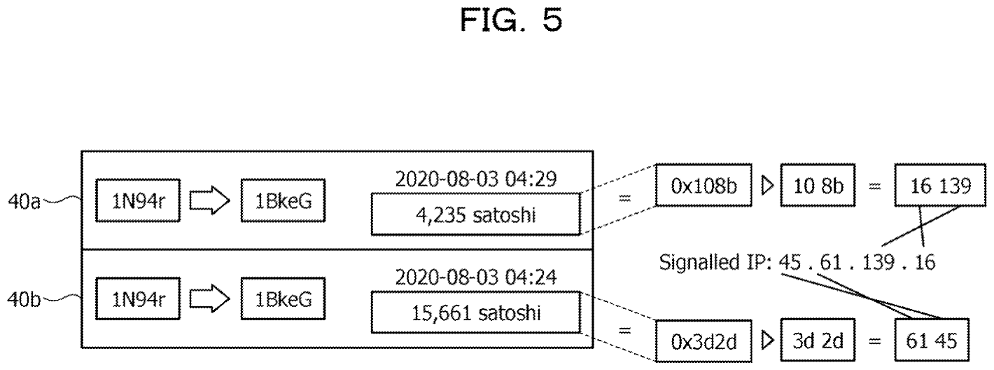

FIG. 5 is an explanatory diagram for explaining an example of a C&C IP concealing method. The left side of FIG. 5 schematically illustrates two transactions 40a and 40b in the blockchain at the bitcoin address 20 used to conceal the address information. In each of the transactions 40a, 40b, the bitcoins are remitted from 1N94r (the first five characters of the bitcoin address) to 1BkeG (the first five characters of the bitcoin address as in the case of 1N94r).

In the transaction 40b, 15,661 satoshi are remitted at 4:24 on Aug. 3, 2020, and these bitcoins actually conceal IP information of 45.61. For example, 15,661 is converted into a hexadecimal number (3D2D), 3D2D is then divided into (3D and 2D), which are then converted into decimal numbers (61 and 45). Next, when these decimal numbers are put in the reverse order and concatenated, the IP information of 45.61 is obtained.

Similarly, in the transaction 40a, 4,235 satoshi are remitted at 4:29 on Aug. 3, 2020. When 4,235 is converted in the same procedure as above, IP information of 139.16 is obtained. These numbers are concatenated to obtain 45.61.139.16. Every time a new transaction is added to the transaction data 22, the C&C IP decryption unit 11 decrypts the C&C IP based on the above conversion procedure and outputs the decrypted C&C IP to the malware information collection unit 13.

Referring back to FIG. 1, the Geo IP conversion unit 12 is a processing unit that uses, as an input, the C&C IP output by the C&C IP decryption unit 11, and outputs C&C Geo IP data 26 into which the C&C IP is converted based on a Geo IP DB 25.

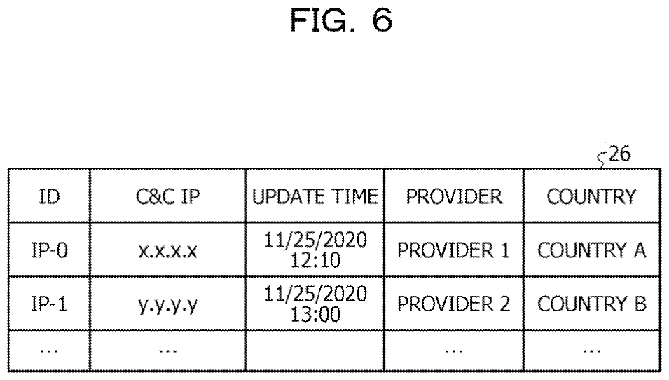

FIG. 6 is an explanatory diagram for explaining an example of the C&C Geo IP data 26. As illustrated in FIG. 6, the Geo IP conversion unit 12 assigns identification information (ID) to the newly observed C&C IP output by the C&C IP decryption unit 11, and stores the assigned identification information into an “ID” column. The Geo IP conversion unit 12 stores the C&C IP decrypted by the C&C IP decryption unit 11 in a “C&C IP” column. In an “UPDATE TIME” column, the Geo IP conversion unit 12 stores the approval time of a second transaction in an operation of updating the C&C IP.

Next, the Geo IP conversion unit 12 refers to a provider (autonomous system) and a country having a C&C IP in the Geo IP DB 25.

As the Geo IP DB 25, for example, GeoLite 2 (Registered Trademark) provided by MaxMind Company or the like is used. The Geo IP conversion unit 12 stores the provider and the country obtained by reference into a “PROVIDER” column and a “COUNTRY” column, respectively.

Referring back to FIG. 1, the malware information collection unit 13 is a processing unit that uses, as an input, the C&C IP output from the C&C IP decryption unit 11, collects threat information 23 such as cyber threat intelligence (CTI) concerning the C&C IP, and outputs the collected malware data 24.

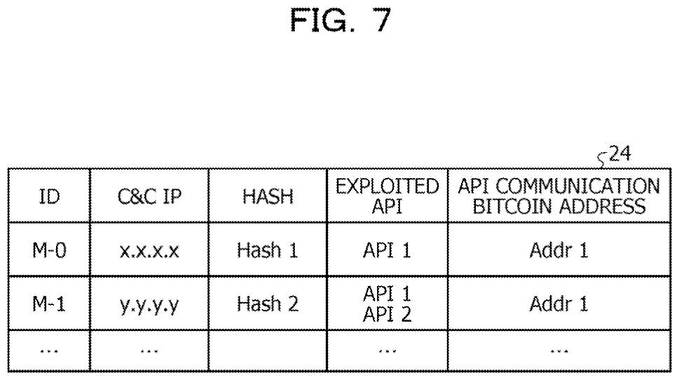

FIG. 7 is an explanatory diagram for explaining an example of the malware data 24. As illustrated in FIG. 7, the malware information collection unit 13 assigns identification information (ID) to the newly observed C&C IP output by the C&C IP decryption unit 11, and stores the assigned identification information into an “ID” column. As similar to the Geo IP conversion unit 12, the malware information collection unit 13 collects the threat information 23 based on the C&C IP by using a site such as a VirusTotal. If the malware information collection unit 13 finds an analysis target that communicates with the C&C IP after executing a certain blockchain application programming interface (API) based on, for example, results of malware dynamic analysis, the malware information collection unit 13 stores the hash value of the malware in a “HASH” column. For the found analysis target (malware information), the malware information collection unit 13 stores the executed API into an “EXPLOITED API” column and the bitcoin address accessed by the malware using the API into an “API COMMUNICATION BITCOIN ADDRESS” column. The malware information collection unit 13 stores the C&C IP in a “C&C IP” column.

Referring back to FIG. 1, the attack scheme change detection unit 14 is a processing unit that detects a change in an attack scheme of a cyberattack using the bitcoin address 20, based on a time-series change in at least one item of the transaction details specified in the collected transaction data 22 and the collected threat information 23. For example, the attack scheme change detection unit 14 uses, as inputs, the transaction data 22, the C&C Geo IP data 26, the malware data 24, and parameter information 27, and outputs a result indicating that a change in the attack scheme is detected as a detection result to the output unit 15.

The parameter information 27 is information on parameters used to detect a time-series change in at least one item included in the collected transaction details and the collected threat information 23. For example, the parameter information 27 includes T_shift that is a parameter for detecting a shift of the transaction time. The parameter information 27 includes T_var that is a parameter for controlling a variance in the transaction time. The parameter information 27 includes W_recent that is a parameter for controlling the latest period. The parameter information 27 includes W_previous that is a parameter for controlling a period immediately preceding W_recent. The parameter information 27 includes δ_up that is a parameter for detecting a short-term sharp rise, and δ_down that is a parameter for detecting a short-term sharp fall. The parameter information 27 also includes δ_up_tendency that is a parameter for detecting a rising tendency during a certain period, and δ_down_tendency that is a parameter for detecting a falling tendency during the certain period.

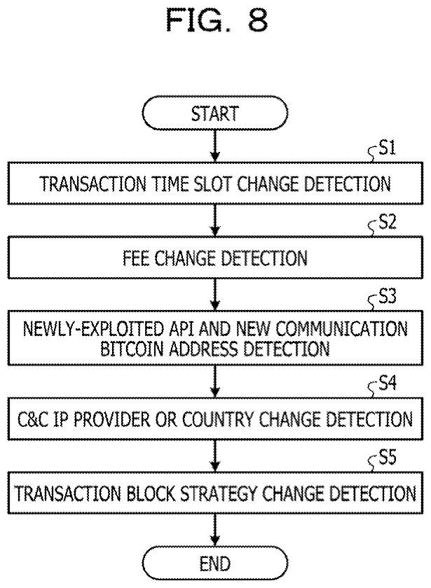

FIG. 8 is a flowchart illustrating an example of attack scheme change detection processing (may be referred to as “attack strategy change detection processing”). As illustrated in FIG. 8, the attack scheme change detection unit 14 perform processing based on the input data sequentially for a transaction time slot change detection (S1), a fee change detection (S2), a newly-exploited API and new communication bitcoin address detection (S3), a C&C IP provider or country change detection (S4), and a transaction block strategy change detection (S5). The attack scheme change detection unit 14 does not have to perform all the processes in S1 to S5, but may perform at least one process designated by an input operation or the like by a user of the information processing apparatus 1.

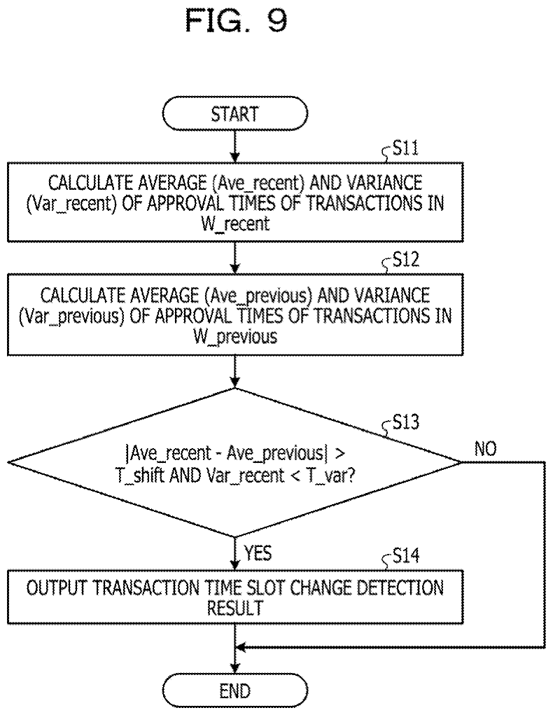

FIG. 9 is a flowchart illustrating an example of a transaction time slot change detection process. As illustrated in FIG. 9, when the transaction time slot change detection process (S1) is started, the attack scheme change detection unit 14 refers to the transaction data 22 and calculates an average (Ave_recent) of the approval times of the transactions within W_recent input as the latest period. Similarly, the attack scheme change detection unit 14 calculates a variance (Var_recent) of the approval times of the transactions within W_recent input as the latest period (S11).

Here, W_recent is basically set to a period in the unit of about one to two weeks, but may be set to a period longer or shorter than that. Since the transaction time is stored in the format such as hh:mm:ss (hh: hour, mm: minute, and ss: second), the attack scheme change detection unit 14 normalizes the transaction times in the units of hours and calculates the average and the variance.

Next, the attack scheme change detection unit 14 calculates an average (Ave_previous) and a variance (Var_previous) of the approval times of the transactions in W_previous input as the period immediately preceding W_recent (S12). W_previous is set to, for example, a one- to two-week period preceding W_recent without overlapping W_recent.

Next, the attack scheme change detection unit 14 determines whether |Ave_recent−Ave_previous| is larger than T_shift and whether Var_recent is smaller than T_var (S13). When |Ave_recent−Ave_previous| is larger than T_shift and Var_recent is smaller than T_var (S13: YES), the attack scheme change detection unit 14 outputs a detection result indicating a change in the transaction time slot (S14) and terminates the process. When the negative determination (No) is made in S13, the attack scheme change detection unit 14 terminates the process without outputting any detection result.

As described above, in the transaction time slot change detection process (S1), the attack scheme change detection unit 14 detects a case where the bitcoin transaction time slot of the attacker changed to a specific time slot, and outputs, as a detection result, information indicating from which time slot to which time slot the transaction time of the attacker changed.

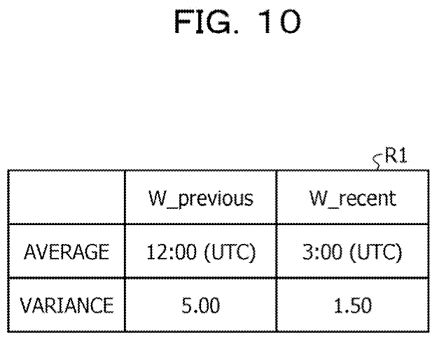

FIG. 10 is an explanatory diagram for explaining an example of a detection result. As illustrated in FIG. 10, the attack scheme change detection unit 14 outputs a detection result R1 in the case where the transaction time slot for the bitcoin address 20 by the attacker changed to a specific time slot. The attack scheme change detection unit 14 stores the value of Ave_previous in “AVERAGE” and the value of Var_previous in “VARIANCE” in a “W_previous” column of the detection result R1. The attack scheme change detection unit 14 stores the value of Ave recent in “AVERAGE” and the value of Var_recent in “VARIANCE” in a “W_recent” column.

In the example of the detection result R1 in FIG. 10, it is detected that the attacker changed bitcoin transaction operations at a daytime time slot to transaction operations at a specific midnight time slot in terms of coordinated universal time (UTC). This is a behavior by an attacker actually observed, and is presumably because the fees sharply rose due to the influence of bitcoin halving, and the attacker changed the time slot in order to avoid a busy period of the transactions. A user of the information processing apparatus 1 may check the detection result R1 and recognize the specific transaction time of the attacker.

Thus, the user of the information processing apparatus 1 may significantly efficiently perform works for the detection.

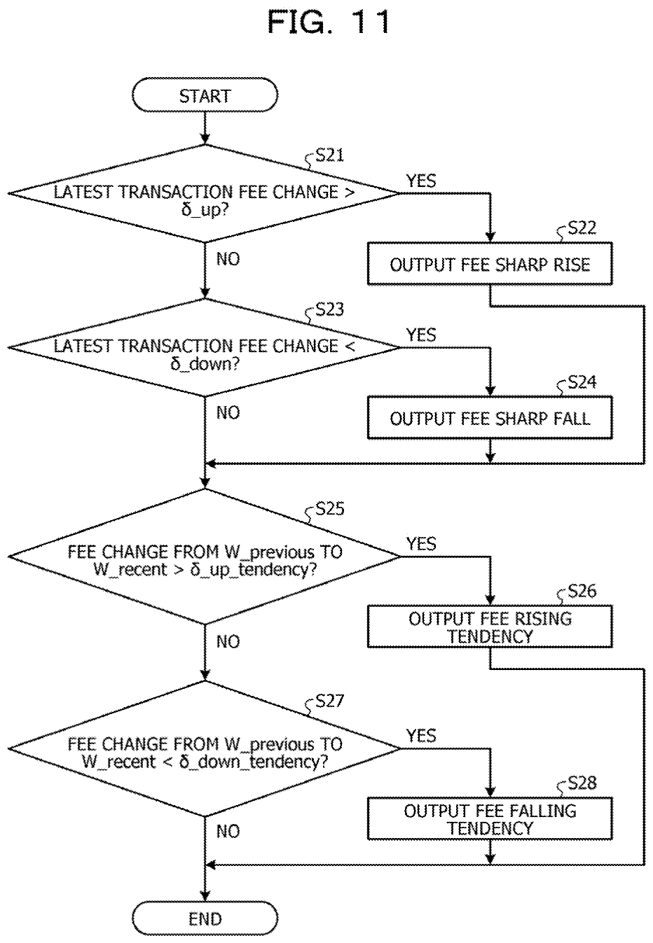

FIG. 11 is a flowchart illustrating an example of a fee change detection process. As illustrated in FIG. 11, when the fee change detection process (S2) is started, the attack scheme change detection unit 14 calculates a latest transaction fee change based on the transaction data 22. For example, since the C&C IP is concealed by using a set of two transactions, the attack scheme change detection unit 14 calculates the ratio between the fees for the first latest transaction and the fees for the third latest transaction (for example, the first latest transaction fees/the third latest transaction fees).

Then, the attack scheme change detection unit 14 determines whether the latest transaction fee change is larger than δ_up (>1.0) (S21). When the latest transaction fee change is larger than δ_up (S21: Yes), the attack scheme change detection unit 14 outputs a fee sharp rise as an attack scheme change (S22), and advances the process to S25. When the latest transaction fee change is not larger than δ_up (S21: No), the attack scheme change detection unit 14 advances the process to S23.

In S23, the attack scheme change detection unit 14 determines whether the latest transaction fee change is smaller than δ_down (0<δ_down <1.0). When the latest transaction fee change is smaller than δ_down (S23: Yes), the attack scheme change detection unit 14 outputs a fee sharp fall as an attack scheme change (S24) and advances the process to S25. When the latest transaction fee change is not smaller than δ_down (S23: No), the attack scheme change detection unit 14 advances the process to S25.

In S25, the attack scheme change detection unit 14 calculates a fee average of the transactions in W_recent and a fee average of the transactions in W_previous. Then, the attack scheme change detection unit 14 calculates the ratio between these averages (the fee average of the transactions in W_recent/the fee average of the transactions in W_previous). Then, the attack scheme change detection unit 14 determines whether the ratio between the fee averages of W_recent and W_previous is larger than δ_up_tendency (>1.0).

When the ratio between the fee averages of W_recent and W_previous is larger than δ_up_tendency (S25: Yes), the attack scheme change detection unit 14 outputs a fee rising tendency as an attack scheme change

(S26), and terminates the process. When the ratio between the fee averages of W_recent and W_previous is not larger than δ_up_tendency (S25: No), the attack scheme change detection unit 14 advances the process to S27.

In S27, the attack scheme change detection unit 14 determines whether the ratio between the fee averages of W_recent and W_previous is smaller than δ_down_tendency (0<δ_down_tendency<1.0). When determining in S27 that the ratio is smaller than δ_down_tendency (S27: Yes), the attack scheme change detection unit 14 outputs a fee falling tendency as an attack scheme change (S28), and terminates the process. When determining in S27 that the ratio is not smaller than the threshold (S27: No), the attack scheme change detection unit 14 just terminates the process.

As described above, the fee change detection process (S2) detects a fee change from two angles, whether the attacker received a temporary influence of a fee sharp rise or the like in the bitcoin market and whether the set fees were increased as a part of the strategy of the attack scheme, and outputs the detected change as a detection result.

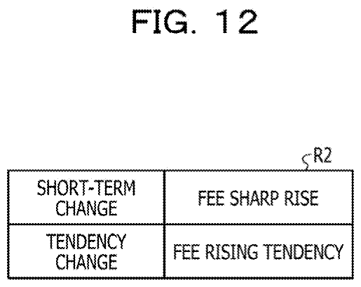

FIG. 12 is an explanatory diagram for explaining an example of a detection result. As illustrated in FIG. 12, the attack scheme change detection unit 14 outputs results detected in the fee change detection process as a detection result R2 (S2). In the detection result R2, “FEE SHARP RISE” is output to a “SHORT-TERM CHANGE” row, and “FEE RISING TENDENCY” is output to a “TENDENCY CHANGE” row.

In behaviors by the attacker actually observed in the detection result R2, phenomena were observed in which high fees were attempted for only several weeks and very high fees had to be set due to the influence of bitcoin halving. The user of the information processing apparatus 1 is enabled to check the detection result R2 to recognize the behaviors by the attacker, and thereby significantly efficiently perform works for the detection.

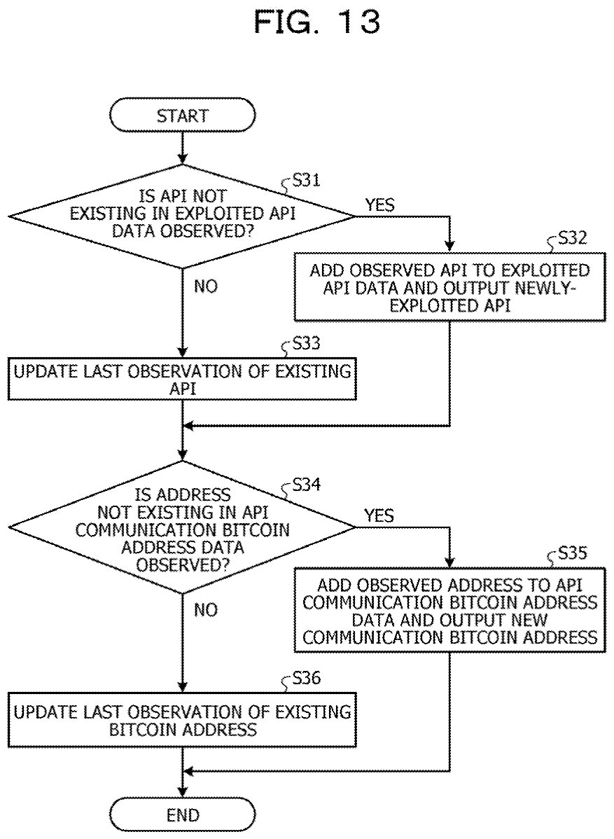

FIG. 13 is a flowchart illustrating an example of a newly-exploited API and new communication bitcoin address detection process. As illustrated in

FIG. 13, when the newly-exploited API and new communication bitcoin address detection process (S3) is started, the attack scheme change detection unit 14 determines whether an API not existing in known exploited APIs set in advance is observed in the input data (S31).

When an API not existing in the exploited APIs is observed (S31: Yes), the attack scheme change detection unit 14 adds the API to the exploited API data, outputs a detection of the new API (S32), and advances the process to the S34.

When the API not existing in the exploited APIs is not observed (S31: No), the attack scheme change detection unit 14 updates the last observation of each API observed among the existing APIs (S33) and advances the process to S34.

In S34, the attack scheme change detection unit 14 determines whether an address not existing in the API communication bitcoin address data is observed in the input data. When an address not existing in the API communication bitcoin address data is observed (S34: Yes), the attack scheme change detection unit 14 adds the address to the API communication bitcoin address data, outputs a detection of the new communication address (S35), and terminates the process.

When an address not existing in the API communication bitcoin address data is not observed (S34: No), the attack scheme change detection unit 14 updates the last observation of each bitcoin address observed among the existing bitcoin addresses (S36), and terminates the process.

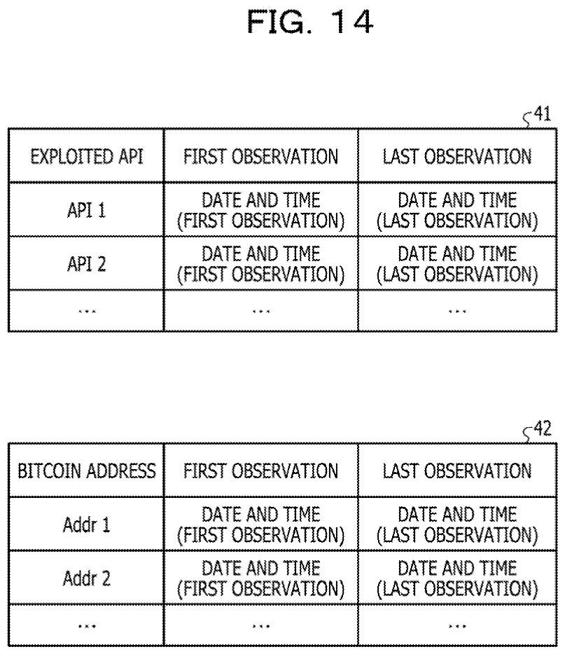

FIG. 14 is an explanatory diagram for explaining an example of exploited API data and API communication bitcoin address data. As illustrated in FIG. 14, in exploited API data 41, “EXPLOITED API” stores each observed API. “FIRST OBSERVATION” stores the date and time when the API was first observed. “LAST OBSERVATION” stores the date and time when the API was lastly observed.

In API communication bitcoin address data 42, “BITCOIN ADDRESS” stores each bitcoin address accessed by malware by way of an API. “FIRST OBSERVATION” and “LAST OBSERVATION” store the same data (the dates and times of the first and last observations) as in the exploited API data 41.

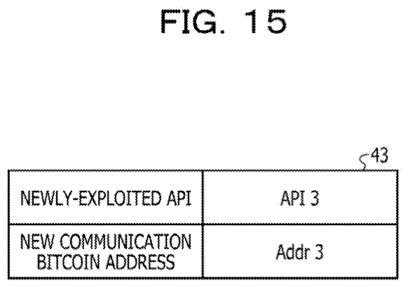

FIG. 15 is an explanatory diagram for explaining an example of newly-exploited API and new communication bitcoin address data. As illustrated in FIG. 15, the attack scheme change detection unit 14 outputs results detected in the newly-exploited API and new communication bitcoin address detection process as newly-exploited API and new communication bitcoin address data 43.

In the newly-exploited API and new communication bitcoin address data 43, “NEWLY-EXPLOITED API” stores “API 3” and “NEW COMMUNICATION BITCOIN ADDRESS” stores “Addr 3”.

Also in an actual operation by the attacker observed in the newly-exploited API and new communication bitcoin address data 43, it was observed that the attacker took an action to set multiple APIs or add an API, because when the API of the blockchain becomes unusable, the malware has no way to obtain any information based on which the C&C communication is performed. An action to change the bitcoin address 20 to be accessed was also observed.

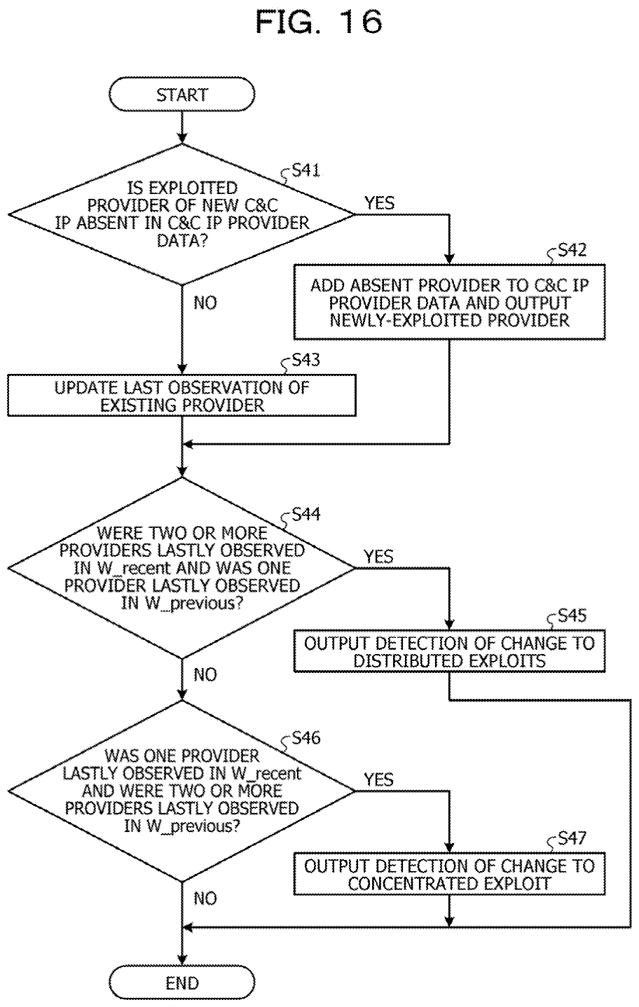

FIG. 16 is a flowchart illustrating an example of a C&C IP provider change detection process. As illustrated in FIG. 16, when the C&C IP provider change detection process is started, the attack scheme change detection unit 14 determines whether an exploited provider of a new C&C IP exists in C&C IP provider data based on the input data (S41).

When the exploited provider of the new C&C IP is absent in the C&C IP provider data (S41: Yes), the attack scheme change detection unit 14 adds the provider to the C&C IP provider data, outputs the newly-exploited provider (S42), and advances the process to S44.

When the exploited provider of the new C&C IP exists in the C&C IP provider data (S41: No), the attack scheme change detection unit 14 updates the last observation of each exploited provider observed among the existing exploited providers (S43), and advances the process to S44.

In S44, the attack scheme change detection unit 14 determines whether the number of providers lastly observed in W_recent is two or more and whether the number of providers lastly observed in W_previous is one. When the affirmative determination is made in S44 (S44: Yes), the attack scheme change detection unit 14 outputs a detection of a change to distributed exploits of the providers of the C&C IPs (S45), and terminates the process. When the negative determination is made in S44 (S44: No), the attack scheme change detection unit 14 advances the process to S46.

In S46, the attack scheme change detection unit 14 determines whether the number of providers lastly observed in W_recent is one and the number of providers lastly observed in W_previous is two or more. When the affirmative determination is made in S46 (S46: Yes), the attack scheme change detection unit 14 outputs a detection of a change to a concentrated exploit of the provider of the C&C IP (S47), and terminates the process. When the negative determination is made in S46 (S46: No), the attack scheme change detection unit 14 just terminates the process.

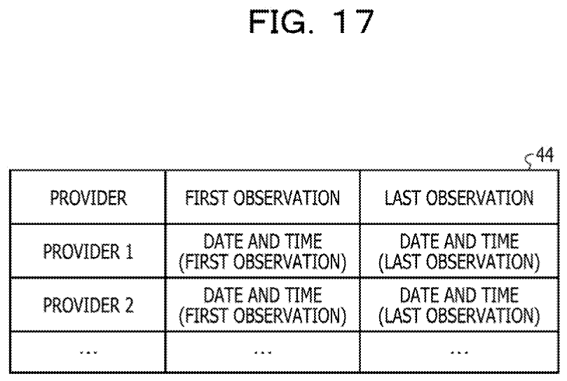

FIG. 17 illustrates an explanatory diagram for explaining an example of the C&C IP provider data. As illustrated in FIG. 17, in C&C IP provider data 44, “PROVIDER” stores each exploited provider. “FIRST OBSERVATION” stores the date and time when the provider was observed first. “LAST OBSERVATION” stores the date and time when the provider was lastly observed.

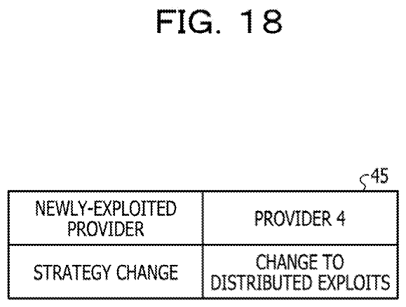

FIG. 18 is an explanatory diagram for explaining an example of C&C IP provider exploit change detection data. As illustrated in FIG. 18, the attack scheme change detection unit 14 outputs the result of the C&C IP provider change detection process as C&C IP provider exploit change detection data 45. In the C&C IP provider exploit change detection data 45, “NEWLY-EXPLOITED PROVIDER” stores “PROVIDER 4” and “STRATEGY CHANGE” stores “CHANGE TO DISTRIBUTED EXPLOITS”.

In an actual operation by the attacker observed in the C&C IP provider exploit change detection data 45, observed was an action of changing the C&C IP provider(s) at a certain time point from a concentrated exploit of a specific provider to distributed exploits of various providers.

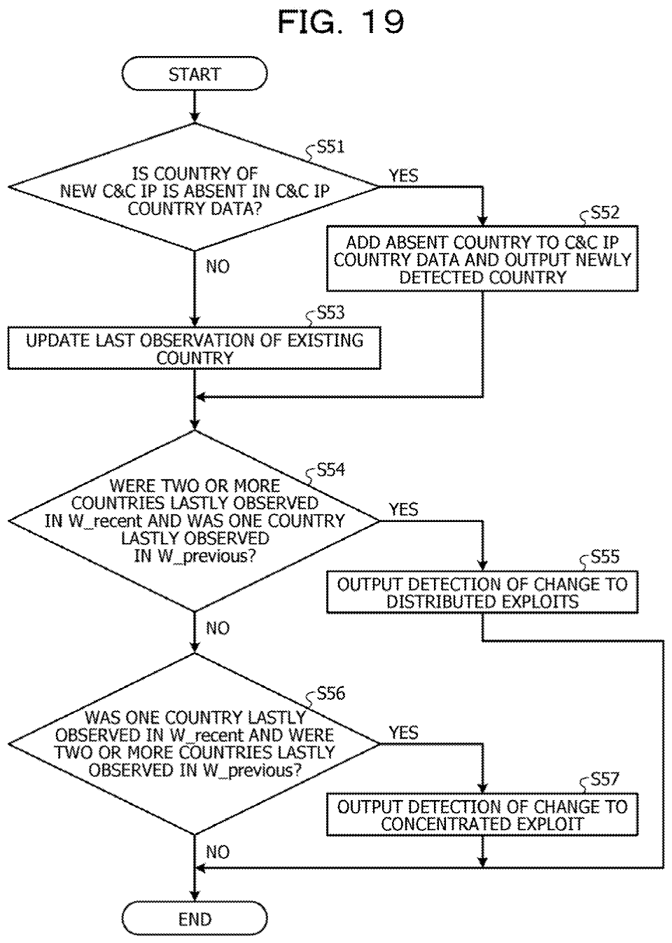

FIG. 19 is a flowchart illustrating an example of a C&C IP country change detection process. As illustrated in FIG. 19, when the C&C IP country change detection process is started, the attack scheme change detection unit 14 determines whether a country of a new C&C IP exists in C&C IP country data based on the input data (S51).

When the country of the new C&C IP is absent in the C&C IP country data (S51: Yes), the attack scheme change detection unit 14 adds the country to the C&C IP country data, outputs the newly detected country (S52), and advances the process to S54.

When the country of the new C&C IP exists in the C&C IP country data (S51: No), the attack scheme change detection unit 14 updates the last observation of each country observed among the existing countries (S53), and advances the process to S54.

In S54, the attack scheme change detection unit 14 determines whether the number of countries lastly observed in W_recent is two or more and whether the number of countries lastly observed in W_previous is one. When the affirmative determination is made in S54 (S54: Yes), the attack scheme change detection unit 14 outputs a detection of a change to distributed exploits of the countries of the C&C IPs (S55), and terminates the process. When the negative determination is made in S54 (S54: No), the attack scheme change detection unit 14 advances the process to S56.

In S56, the attack scheme change detection unit 14 determines whether the number of countries lastly observed in W_recent is one and the number of countries lastly observed in W_previous is two or more. When the affirmative determination is made in the S56 (S56: Yes), the attack scheme change detection unit 14 outputs a detection of a change to a concentrated exploit of the country of the C&C IP (S57), and terminates the process. When the negative determination is made in S56 (S56: No), the attack scheme change detection unit 14 just terminates the process.

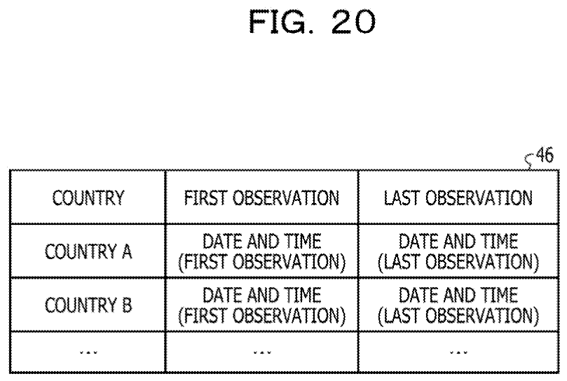

FIG. 20 is an explanatory diagram for explaining an example of C&C IP country data. As illustrated in FIG. 20, in C&C IP country data 46, “COUNTRY” stores a country to which each C&C IP belongs. “FIRST OBSERVATION” stores the date and time when the country was first observed. “LAST OBSERVATION” stores the date and time when the country was lastly observed.

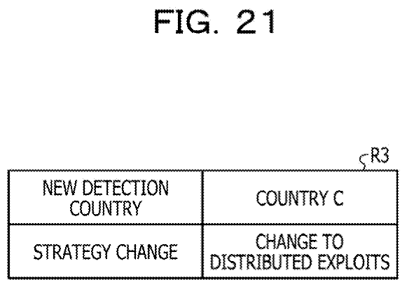

FIG. 21 is an explanatory diagram for explaining an example of a detection result. As illustrated in FIG. 21, the attack scheme change detection unit 14 outputs a result of the C&C IP country change detection process as a detection result R3. In the detection result R3, “NEWLY DETECTED COUNTRY” stores “COUNTRY C” and “STRATEGY CHANGE” stores “CHANGE TO DISTRIBUTED EXPLOITS”.

In an actual operation by the attacker observed in the detection result R3, a change regarding the C&C IP countries was observed from a concentrated operation using IPs of a specific county to a distributed operation using IPs of various countries as is the case with the providers.

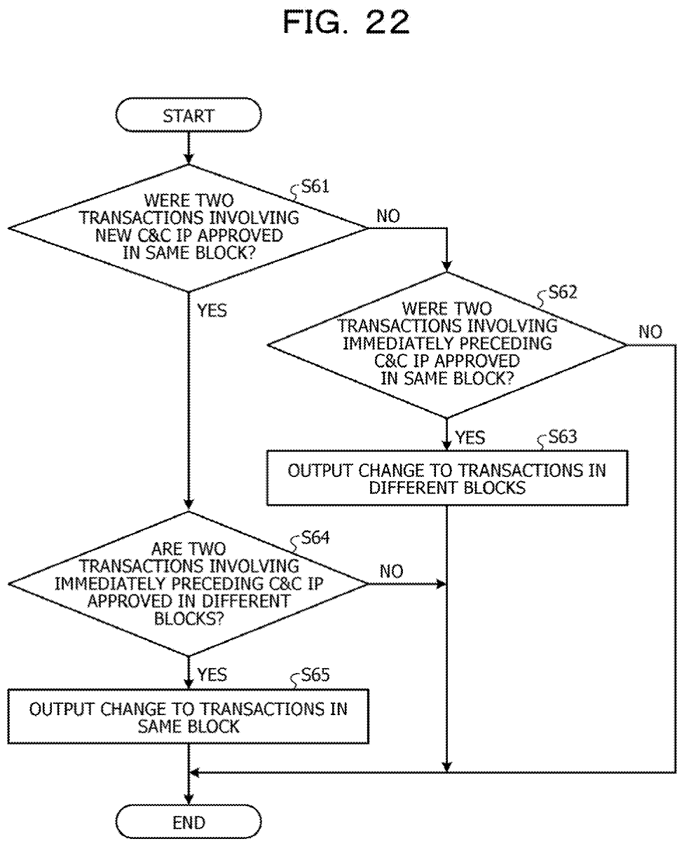

FIG. 22 is a flowchart illustrating an example of a transaction block strategy change detection process. As illustrated in FIG. 22, when the transaction block strategy change detection process (S5) is started, the attack scheme change detection unit 14 determines whether two transactions involving a new C&C IP were confirmed in the same block based on the input data (S61).

When the two transactions were confirmed in the same block (S61: Yes), the attack scheme change detection unit 14 advances the process to S64. When the two transactions were not approved in the same block (S61: No), the attack scheme change detection unit 14 advances the process to S62.

In S62, the attack scheme change detection unit 14 determines whether two transactions involving the immediately preceding C&C IP were confirmed in the same block. When the affirmative determination is made in S62 (S62: Yes), the attack scheme change detection unit 14 outputs a change to the transactions in the different blocks (S63), and terminates the process. When the negative determination is made in S62 (S62: No), the attack scheme change detection unit 14 just terminates the process.

In S64, the attack scheme change detection unit 14 determines whether two transactions involving the immediately preceding C&C IP were confirmed in different blocks. When the affirmative determination is made in S64 (S64: Yes), the attack scheme change detection unit 14 outputs a change to the transactions in the same block (S65), and terminates the process. When the negative determination is made in S64 (S64: No), the attack scheme change detection unit 14 just terminates the process.

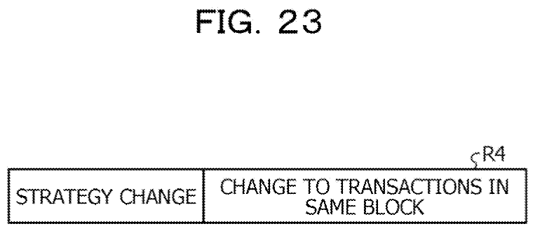

FIG. 23 is an explanatory diagram for explaining an example of a detection result. As illustrated in FIG. 23, the attack scheme change detection unit 14 outputs a result of the transaction block strategy change detection process as a detection result R4. In the detection result R4, “CHANGE TO TRANSACTIONS IN SAME BLOCK” is output in “STRATEGY CHANGE”.

In an actual operation by the attacker observed in the detection result R4, an operation of causing a first transaction to be confirmed first and then causing a second transaction to be confirmed and an operation of causing two transactions to be confirmed in the same block were attempted, and trial and error of the two strategies were observed.

Referring back to FIG. 1, the output unit 15 is a processing unit that outputs processing results and so on in the form of a files or displays. For example, the output unit 15 outputs the detection results (R1 to R4) of the attack scheme change detection unit 14 on a display or the like. Thus, the user of the information processing apparatus 1 is enabled to recognize a change in the attack scheme of the cyberattack.

As described above, the information processing apparatus 1 collects transaction data (transaction data 22) concerning a specific virtual currency address (bitcoin address 20) from the blockchain (bitcoin blockchain 21). The information processing apparatus 1 decrypts the address information (for example, C&C IP) based on the transaction details specified in the collected transaction data 22. Based on the decrypted C&C IP, the information processing apparatus 1 collects the threat information 23 concerning the C&C IP. The information processing apparatus 1 detects a change in an attack scheme of a cyberattack using the bitcoin address 20 based on a time-series change in at least one item included in the transaction details specified in the collected transaction data 22 and the collected threat information 23.

Thus, the information processing apparatus 1 is able to detect a time-series change in an attack scheme of a cyberattack in which address information involved in C&C communication is concealed using the blockchain.

Based on the detection result of the information processing apparatus 1, the user of the information processing apparatus 1 (for example, a researcher on the defending side) is enabled to advance investigation of a strategy change in the cyberattack using the blockchain.

The information processing apparatus 1 detects a change in the transaction time slot for the bitcoin address 20 based on a time-series change in the transaction time included in the transaction details specified in the transaction data 22 concerning the bitcoin address 20. Thus, the user of the information processing apparatus 1 is enabled to easily find out a change in the attack strategy, such as a change in the transaction time related to the bitcoin address 20 to be used for concealing the address information for the C&C communication.

The information processing apparatus 1 detects a change in the fees related to the cyberattack based on a time-series change in the fees included in the transaction details specified in the transaction data 22 concerning the bitcoin address 20. Thus, the user of the information processing apparatus 1 is enabled to easily find out a phenomenon of a change in the attack strategy such as a change in the transaction fees related to the bitcoin address 20 to be used to conceal the address information for the C&C communication.

The information processing apparatus 1 detects a change in the API involved in the cyberattack based on a time-series change in the API information included in the threat information 23. Thus, the user of the information processing apparatus 1 is enabled to easily find out a phenomenon of a change in the attack strategy such as a change in the transaction fees related to the bitcoin address 20 to be used to conceal the address information for the C&C communication.

The information processing apparatus 1 detects a change in the provider or country of the C&C server related to the cyberattack based on a time-series change in the C&C IP decrypted based on the transaction details specified in the collected transaction data 22. Thus, the user of the information processing apparatus 1 is enabled to easily find out a change in the attack strategy due to a change in the provider or country of the C&C server involved in a cyberattack, for example.

The information processing apparatus 1 detects a change regarding whether to make a notification of a C&C IP involved in a cyberattack by using multiple blocks or using a single block, based on one or more blocks in which the approvals were made in the bitcoin blockchain 21 and which are included in the transaction details used to decrypt the C&C IP. Thus, the user of the information processing apparatus 1 is enabled to easily find out a change in the attack strategy, for example, a change regarding whether to make the notification of the C&C IP involved in the cyberattack by using multiple blocks or using a single block in the bitcoin blockchain 21.

It is noted that the components of the apparatuses illustrated in the drawings are not necessarily physically configured as illustrated in the drawings. For example, a specific form of the distribution or integration in each apparatus are is limited to those illustrated in the drawings. The entirety or part of the apparatus may be configured by being functionally or physically distributed or integrated into any units depending on various loads, usage situations, and the like.

All or certain some of the various processing functions to be executed by the information processing apparatus 1 may be executed by a central processing unit (CPU) (or a microcomputer such as a microprocessor unit (MPU) or a micro controller unit (MCU)). All or certain some of the various processing functions may be executed on a program analyzed and executed by the CPU (or the microcomputer such as the MPU or the MCU) or may be executed on hardware using wired logic. The various processing functions to be executed by the information processing apparatus 1 may be executed by cloud computing in which multiple computers collaborate with each other.

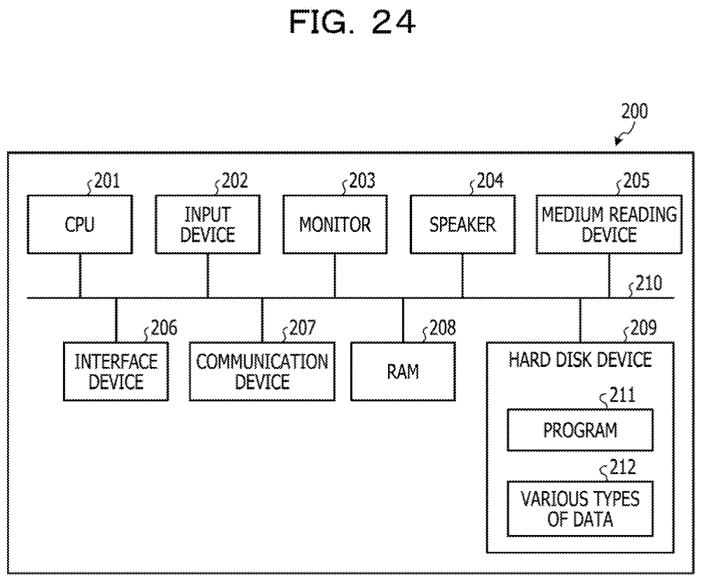

The various processes described in the above embodiments may be implemented by the computer executing a program prepared in advance. Hereinafter, an example of a computer configuration (hardware) that executes the program having the same functions as in the above-described embodiments will be described. FIG. 24 is a block diagram illustrating an example of the computer configuration.

As illustrated in FIG. 24, a computer 200 includes a CPU 201 that executes various arithmetic processes, an input device 202 that receives data input, a monitor 203, and a speaker 204. The computer 200 also includes a medium reading device 205 that reads the program and so on from a storage medium, an interface device 206 for coupling to various devices, and a communication device 207 for wired or wireless communication coupling to an external apparatus. The computer 200 includes a random-access memory (RAM) 208 that temporarily stores various types of information, and a hard disk device 209. The components (201 to 209) in the computer 200 are coupled to a bus 210.

The hard disk device 209 stores a program 211 for executing the various processes in the functional configurations described in the above embodiments (for example, the bitcoin transaction information collection unit 10, the C&C IP decryption unit 11, the Geo IP conversion unit 12, the malware information collection unit 13, the attack scheme change detection unit 14, and the output unit 15). The hard disk device 209 also stores various types of data 212 to be referred to by the program 211. The input device 202 receives, for example, inputs of operation information from an operator. The monitor 203 displays, for example, various screens to be operated by the operator. For example, a printer or the like is coupled to the interface device 206. The communication device 207 is coupled to a communication network such as a local area network (LAN) and exchanges various types of information with the external apparatus via the communication network.

The CPU 201 reads the program 211 stored in the hard disk device 209, loads the program 211 into the RAM 208, and executes the program 211 to perform the various processes for the above-described functional configurations (for example, the bitcoin transaction information collection unit 10, the C&C IP decryption unit 11, the Geo IP conversion unit 12, the malware information collection unit 13, the attack scheme change detection unit 14, and the output unit 15). The program 211 does not have to be stored in the hard disk device 209. For example, the program 211 stored in a storage medium readable by the computer 200 may be read and executed. For example, as the storage medium readable by the computer 200, a portable storage medium such as a compact disc read-only memory (CD-ROM), a Digital Versatile Disc (DVD), or a Universal Serial Bus (USB) memory, a semiconductor memory such as a flash memory, a hard disk drive, or the like may be used. The program 211 may be stored in a device coupled to a public network, the Internet, a LAN, or the like, and the computer 200 may read and execute the program 211 from the device.

Regarding the embodiments above, the following appendices will be further disclosed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program, the program causing a compute to execute a process comprising:
collecting transaction data concerning a specific virtual currency address from a blockchain;
decrypting address information based on transaction details specified in the collected transaction data;
collecting threat information concerning the address information based on the decrypted address information; and
detecting a change in an attack scheme of a cyberattack using the virtual currency address, based on a time-series change in at least one item included in the transaction details specified in the collected transaction data and the collected threat information.

2. The recording medium according to claim 1, wherein
the detecting includes detecting a change in a transaction time slot for the virtual currency address based on a time-series change in a transaction time included in the transaction details.

3. The recording medium according to claim 1, wherein,
the detecting includes detecting a change in fees involved in the cyberattack based on a time-series change in the fees included in the transaction details.

4. The recording medium according to claim 1, wherein
the detecting includes detecting a change in an application programming interface (API) involved in the cyberattack based on a time-series change in API information included in the threat information.

5. The recording medium according to claim 1, wherein
the detecting includes detecting a change in a provider or a country of a C&C server involved in the cyberattack based on a time-series change in the address information.

6. The recording medium according to claim 1, wherein
the detecting includes detecting, based on one or more blocks in which approvals were made in the blockchain and which are included in the transaction details used to decrypt the address information, a change regarding whether to make a notification of the address information involved in the cyberattack by using a plurality of blocks or using a single block.

7. A computer-implemented method comprising:
collecting transaction data concerning a specific virtual currency address from a blockchain;
decrypting address information based on transaction details specified in the collected transaction data;
collecting threat information concerning the address information based on the decrypted address information; and
detecting a change in an attack scheme of a cyberattack using the virtual currency address, based on a time-series change in at least one item included in the transaction details specified in the collected transaction data and the collected threat information.

8. An information processing apparatus comprising:
a memory; and
a processor coupled to the memory, the processor being configured to perform processing, the processing including:
collecting transaction data concerning a specific virtual currency address from a blockchain;
decrypting address information based on transaction details specified in the collected transaction data;
collecting threat information concerning the address information based on the decrypted address information; and
detecting a change in an attack scheme of a cyberattack using the virtual currency address, based on a time-series change in at least one item included in the transaction details specified in the collected transaction data and the collected threat information.
